(19) United States
(12) Patent Application Publication
(10) Pub. No.: US 2026/0351803 A1
(43) Pub. Date: Nov. 5, 2026

(54) BATTERY RACK

(71) Applicant: SAMSUNG SDI CO., LTD., Yongin-si (KR)

(72) Inventor: Doil LEE, Yongin-si (KR)

(21) Appl. No.: 19/430,626

(22) Filed: Dec. 23, 2025

(30) Foreign Application Priority Data
May 2, 2025 (KR) 10-2025-0058536

(51) Int. Cl. H01M 50/503; H01M 50/209; H01M 50/249; H01M 50/507; H02K 11/00

(52) U.S. Cl. CPC H01M 50/503; H01M 50/209; H01M 50/249; H01M 50/507; H01M 2220/20; H02K 11/0094

(57) ABSTRACT

A battery rack includes a first battery module that includes a first set of battery cells and a first connection member electrically connected to a first terminal of the first set of battery cells. The battery rack also includes a second battery module that includes a second set of battery cells and a second connection member electrically connected to a second terminal of the second set of battery cells. A module busbar electrically connects the first connection member and the second connection member,. A driving module is configured to control an electrical connection between the first connection member and the module busbar.

### CROSS-REFERENCE TO RELATED APPLICATION

The present application claims priority to and the benefit of Korean Application No. 10-2025-0058536, filed on May 02, 2025, in the Korean Intellectual Property Office, the entire disclosure of which is incorporated by reference herein.

### BACKGROUND

### Field

The present disclosure relates to a battery rack including a driving module that controls an electrical connection between a connection member and a module busbar.

### DESCRIPTION OF THE RELATED ART

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Heat may be generated when a secondary battery is being charged and/or discharged. If the heat generation continues, thermal runaway of the secondary battery can occur, which may cause a fire in a device or system in which the secondary battery is mounted. To prevent this, it is desirable to control the electrical connection of the secondary battery. For example, before thermal runaway occurs, the electrical connection of the secondary battery or the battery module may be controlled through a system or by an administrator.

The above information disclosed in this Background section is for enhancement of understanding of the background of the present disclosure, and therefore, it may contain information that does not constitute related (or prior) art.

### SUMMARY

The present disclosure provides a battery rack for solving the above-described problems.

These and other aspects and features of the present disclosure will be described in or will be apparent from the following description of embodiments of the present disclosure.

In some embodiments, a battery rack includes a first battery module including a first set of battery cells, and a first connection member electrically connected to a first terminal of the first set of battery cells, a second battery module including a second set of battery cells, and a second connection member electrically connected to a second terminal of the second set of battery cells, a module busbar electrically connecting the first connection member and the second connection member, and a driving module configured to control an electrical connection between the first connection member and the module busbar, the driving module including a motor.

In some embodiments, the battery rack may further include a controller configured to control the first driving module to block the electrical connection between the first connection member and the module busbar in response to a predetermined condition.

In some embodiments, the first connection member may include a first conductive part capable of being energized, and a first insulating part to which the module busbar is connected, and the first driving module is configured to move the first conductive part such that the module busbar and the conductive part are in contact or are separated.

In some embodiments, the conductive part and the insulating part face each other, and the conductive part and the insulating part are coupled in a sliding manner so to be movable in a direction toward or away from each other.

In some embodiments, the first driving module may include a rack and pinion gear connected to the conductive part, and a first motor is configured to rotationally drive the rack and pinion gear.

In some embodiments, the module busbar may include a first terminal part coupled to the insulating part, a second terminal part connected to the second connection member, and a body part connecting the first terminal part and the second terminal part.

In some embodiments, the module busbar may further include an insulating film surrounding the body part.

In some embodiments, the battery rack may further include a second driving module configured to control an electrical connection between the second connection member and the module busbar, with the second driving module including a second motor, wherein the second connection member may include a second conductive part capable of being energized and a second insulating part to which the module busbar is connected, and the second driving module is configured to move the second conductive part such that the module busbar and the second conductive part are in contact or are separated.

In some embodiments, the second connection member may be fixedly coupled to the second terminal part.

In some embodiments, the module busbar may include an inner busbar connected to the first connection member, and an outer busbar for electrically connecting the inner busbar and the second connection member, and the first driving module is configured to control an electrical connection between the inner busbar and the outer busbar.

In some embodiments, the driving module may include a shaft coupled to the inner busbar to move together with the inner busbar, and the motor is configured to move the first shaft in an axial direction, and as the shaft moves the inner busbar into contact with or separate from the inner busbar from the outer busbar, the electrical connection between the inner busbar and the outer busbar is controlled.

In some embodiments, the outer busbar may include a through-hole through which the shaft extends, and a diameter of the through-hole is greater than a width of the shaft.

In some embodiments, the first connection member may include an insertion part into which the inner busbar is inserted, and the inner busbar may include a bent part inserted into the insertion part.

In some embodiments, a length of the bent part may be longer than a distance that the first inner busbar can move in a length direction of the shaft.

In some embodiments, the driving module may include a second shaft electrically connected to the inner busbar, and a second motor configured to rotate and move the second shaft in an axial direction, and as the second shaft moves to contact or separate from the outer busbar, the electrical connection between the first inner busbar and the outer busbar is controlled.

In some embodiments, the second shaft may include a male screw part, the outer busbar may include a female screw hole corresponding to the male screw part, and the male screw part of the second shaft is is configured to be screwed into into or detached from the female screw hole.

In some embodiments, the outer busbar may further include a fixing part coupled and fixed to the second connection member.

In some embodiments, the module busbar may further include a second inner busbar connected to the second connection member and electrically connected to the first inner busbar by the outer busbar, and the battery rack further may include a second driving module configured to control the electrical connection between the second inner busbar and the outer busbar, with the second driving module including a second driving motor.

In some embodiments, the battery rack may further include an insulating case covering an end of the module busbar connected to the first connection member.

In some embodiments, a battery rack includes a first battery module including a first set of battery cells, and a first connection member electrically connected to a first terminal of the first set of battery cells, a second battery module including a second set of battery cells, and a second connection member electrically connected to a second terminal of the second set of battery cells, a module busbar electrically connecting the first connection member and the second connection member, a driving module configured to move at least a part of the first connection member or at least a part of the module busbar to control an electrical connection between the first connection member and the module busbar, the driving module including a motor, and a controller configured to control the driving module to block the electrical connection between the first connection member and the module busbar in response to a predetermined condition.

According to embodiments of the present disclosure, a voltage of a battery rack may be controlled by controlling an electrical connection of a module busbar connecting battery modules included in the battery rack.

According to embodiments of the present disclosure, an electrical connection between any one battery module and another battery module among a plurality of battery modules included in a battery rack may be individually controlled.

According to embodiments of the present disclosure, by individually controlling the electrical connection between a plurality of battery modules included in a battery rack, the battery rack may be more stably controlled in an emergency situation such as heat generation or a fire occurring in the battery rack.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view of a battery cell according to an embodiment of the present disclosure.

FIG. 2 is an exploded perspective view in which a part of a battery module according to an embodiment of the present disclosure is disassembled.

FIG. 3 illustrates a battery rack according to an embodiment of the present disclosure.

FIG. 4 illustrates a first battery module and a second battery module according to an embodiment of the present disclosure.

FIG. 5 illustrates an area around a connection member according to an embodiment of the present disclosure.

FIG. 6 is a cross-sectional view of a battery module according to an embodiment of the present disclosure.

FIG. 7 illustrates a state in which a driving part and a terminal part are separated according to an embodiment of the present disclosure.

FIG. 8 illustrates a state in which a driving part and a terminal part are in contact according to an embodiment of the present disclosure.

FIG. 9 illustrates a first battery module and a second battery module according to another embodiment of the present disclosure.

FIG. 10 is a cross-sectional view of a battery module according to another embodiment of the present disclosure.

FIG. 11 is a perspective view of a busbar, a connection member, and a driving module according to another embodiment of the present disclosure.

FIG. 12 illustrates an inner busbar and an outer busbar are separated according to a first embodiment of the present disclosure.

FIG. 13 illustrates a state in which an inner busbar and an outer busbar are in contact according to the first embodiment of the present disclosure.

FIG. 14 illustrates a state in which a shaft and an outer busbar are separated according to a second embodiment of the present disclosure.

FIG. 15 illustrates a state in which an inner busbar and an outer busbar are in contact according to the second embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being "linked," "coupled," or "connected" to another component, the elements may be directly “coupled,” “linked” or "connected" to each other, or another component may be "interposed" between the components".

Throughout the specification, when "A and/or B" is stated, it means A, B or A and B, unless otherwise stated. That is, “and/or” includes any or all combinations of a plurality of items enumerated. When "C to D" is stated, it means C or more and D or less, unless otherwise specified.

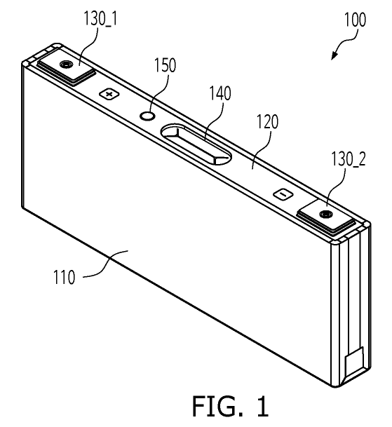

FIG. 1 is a perspective view of a battery cell 100 according to an embodiment of the present disclosure. The battery cell 100 may include one or more electrode assemblies in which a separator, which is an insulator, is interposed between a positive electrode and a negative electrode. The electrode assembly may be wound or stacked. The electrode assembly is accommodated in a case 110, and a cap plate 120 coupled to an open end of the case 110. The battery cell 100 illustrated in FIG. 1 may be a type of secondary battery.

The positive electrode and the negative electrode may include a coating part, which is an area where an active material is applied to a current collector formed of a thin metal foil. The positive and negative electrodes may also include an uncoated part, which is an area of the current collector where the active material is not coated. The positive electrode and the negative electrode may be wound with the separator

interposed between the electrodes. However, the present disclosure is not limited thereto. In other embodiments, the electrode assembly may have a structure in which positive electrodes and negative electrodes are made of a plurality of sheets that are alternately stacked with a separator between each pair of positive and negative electrodes.

The case 110 forms the outer appearance of the battery cell 100 and may be formed of a conductive metal such as aluminum, an aluminum alloy, stainless steel (for example, stainless steel (SUS)), or nickel-plated steel. The case 110 provides a space for accommodating the electrode assembly. In the example depicted in FIG. 1, the case 110 is illustrated as a prismatic case, and the battery cell 100 is illustrated as a prismatic battery cell. But the present disclosure is not limited thereto. In other examples, the battery cell 100 may be a battery cell of various shapes, such as prismatic, cylindrical, pouch-type, coin-type, etc.

The cap plate 120 may be coupled to the case 110 at an open end to seal the case 110. The case 110 and the cap plate 120 may be made of a conductive material. According to an embodiment, an upper end of the case 110 may be opened, and the cap plate 120 may seal the open upper end.

A positive electrode terminal 130_1 electrically connected to the positive electrode and a negative electrode terminal 130_2 electrically connected to the negative electrode may be formed on the cap plate 120. For example, the positive and negative electrode terminals 130_1 and 130_2 may penetrate the cap plate 120 and protrude outward.

According to an embodiment, a vent part 140 may be formed on at least one surface of the battery cell 100. In the example illustrated in FIG. 1, the vent part 140 is formed in an upper surface of the cap plate 120. The vent part 140 may be configured to open when an internal pressure of the battery cell becomes greater than or equal to a predetermined critical pressure. The vent part 140 may form a discharge passage for venting the gas generated inside the battery cell 100.

The cap plate 120 may include an electrolyte injection port 150. The electrolyte injection port 150 may be a through-hole formed in the cap plate 120 and may be passage through which an electrolyte is injected into the case 110 after the cap plate 120 is coupled to the case 110 and to seal the opening. The electrolyte injection port 150 may be sealed with a sealing member after the electrolyte is injected.

The battery cell 100 may be a lithium battery cell, a sodium battery cell, or the like. However, the scope of the present disclosure is not limited to such types of battery. Rather, the battery cell 100 includes various types of batteries that can repeatedly provide electricity through charging and discharging.

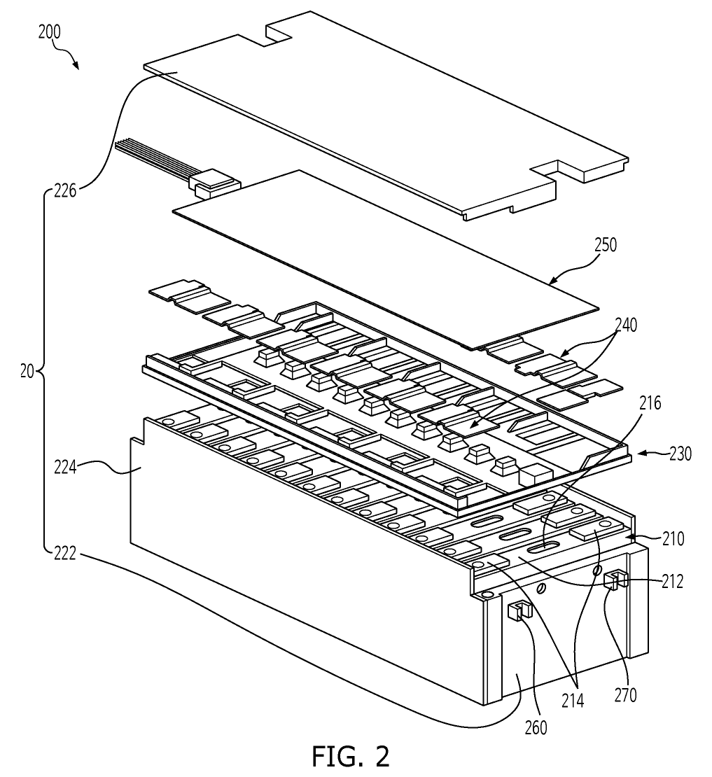

The battery cell 100 may correspond to the battery cells 210, 320, and 330 included in battery modules 200 and 300, which will be described below with reference to FIGS. 2-4.

FIG. 2 is an exploded perspective view in which a part of a battery module 200 according to an embodiment of the present disclosure is disassembled. Referring to FIG. 2, the battery module 200 according to the present invention may include a set of battery cells 210 and a module frame 220 that accommodates the set of battery cells 210. A plurality of busbars 240 are electrically connected to the set of battery cells 210, and a busbar holder 230 that supports the plurality of busbars 240. A circuit 250 is electrically connected to the busbars 240, and various circuits and components are mounted on the circuit 250. In examples, the battery module 200 may be included in a vehicle, an energy storage system (ESS), or the like.

The battery module 200 may include a set of battery cells 210. According to an embodiment, the set of battery cells 210 may be arranged in the battery module 200 in one direction such that the wide surfaces of the respective battery cells face each other. Although FIG. 2 illustrates battery cells arranged in a single row within the battery module 200, the present disclosure is not limited thereto, and the battery cells may be arranged in multiple rows.

Each of the battery cells 210 may include a case, an electrode assembly accommodated with an electrolyte inside the case, and a cap plate 212 for sealing the case. A positive electrode terminal and a negative electrode terminal 214 formed on the cap plate 212 may be electrically connected to the busbar 240. However, the structure of the battery cells 210 is not limited to such a configuration and may vary. Further, the number and arrangement of the battery cells 210 are not limited to the structure shown in FIG. 2 and may be changed as necessary.

The battery cells 210 may be accommodated in a module frame 220. The module frame 220 may include a pair of end plates 222 that contact the outermost battery cells in the arrangement direction of the battery cells, a pair of side plates 224 coupled to the end plates 222, and a top plate 226 disposed on top of the circuit 250.

Although not illustrated, a bottom plate may be provided at a lower part of the battery cells 210 to support the battery cells 210 from below. The battery cells 210, the busbar holder 230, the busbars 240, and the circuit 250 may be accommodated inside the module frame 220.

As shown in FIG. 2, the busbar holder 230 may be disposed on top of the cap plate 212 and may support the busbars 240. In an example, the busbar holder 230 may be a substantially rectangular plate and may be made of an insulating material.

A plurality of through-holes through which the positive electrode terminals and the negative electrode terminals 214 of the cap plates 212 are exposed may be formed in the busbar holder 230. The positive and negative electrode terminals 214 exposed through the through-holes formed in the busbar holder 230 may be electrically connected to the busbars 240.

A plurality of through-parts may be formed in the busbar holder 230. The through-parts may extend through the busbar holder 230. In this case, the through-parts may be formed at positions corresponding to the vent parts 216 of each battery cell 210. As such, the through-parts may form passages through which vent gas discharged through the vent parts 216 flows.

The busbar 240 may electrically connect the positive electrode terminals and the negative electrode terminals 214. The busbar 240 may connect the battery cells 210 in series and/or in parallel. For this purpose, a plurality of busbars 240 may be provided. According to an embodiment, the busbar 240 may electrically connect a positive electrode terminal of a battery cell 210 and a positive electrode terminal or a negative electrode terminal 214 of another battery cell 210. The busbar 240 may also electrically connect a negative electrode terminal of the battery cell 210 and a positive electrode terminal or a negative electrode terminal 214 of another battery cell 210. The busbar 240 may be connected to the terminals 214 by a method such as welding. An area other than the positive and negative electrode terminals 214 among the battery cells 210 may be insulated from the busbar 240 by the busbar holder 230.

A circuit 250 may be interposed between the busbar 240 and the top plate 226, and the busbar 240 may be electrically connected to the circuit 250. According to an embodiment, the circuit 250 may have a substantially rectangular shape and may be located on top of the busbar holder 230. The circuit 250 may be disposed adjacent the busbar 240 to enable smooth connection with the busbar 240.

Various components for measuring state information of the battery cells 210, such as voltage and/or temperature of the battery cells 210, and various components or circuits for controlling and/or managing the battery cells 210 may be mounted on the circuit 250. The circuit 250 may be electrically connected to outside of the battery module 200 by a separate connector.

According to an embodiment, the circuit 250 may include a battery management module (BMM). The battery management module may be configured to monitor the voltage, current, temperature, etc. of the battery cells 210 to monitor the state of the set of battery cells 210 included in the battery module 200 and to manage battery charging and discharging. In other embodiments, the battery management module may not be included in the circuit 250 but may be disposed within the battery module 200 as a separate component. For example, the battery management module may be attached to the end plate 222.

A battery management module that monitors the battery module 200 may be connected to a battery controller (BC). According to an embodiment, the battery controller may be connected to a plurality of battery management modules. For example, the battery controller and the plurality of battery management modules may be connected in a daisy chain manner. That is, a plurality of battery management modules that monitor each of the plurality of battery modules 200 may be integrally managed by the battery controller. As such, the battery controller may monitor the entire battery rack (not shown) composed of the battery modules 200.

The battery module 200 may include a first connection member 260 and a second connection member 270 disposed on the module frame 220. Referring to FIG. 2, the first connection member 260 and the second connection member 270 may be disposed on the end plate 222. However, the present disclosure is not limited thereto, and the connection members may be disposed on the side plate 224, the top plate 226, etc.

The first connection member 260 may be electrically connected to a first terminal (for example, a positive electrode terminal or a negative electrode terminal) of the battery cells 210. The first connection member 260 may be electrically connected to the first terminal of the battery cells 210 by being connected to the busbar 240 and/or the circuit 250 that is electrically connected to the first terminal of the battery cells 210. Similarly, the second connection member 270 may be electrically connected to a second terminal (for example, a negative electrode terminal or a positive electrode terminal) of the battery cells 210. The connection members 260 and 270 may be connected to a module busbar (not shown), and the module busbar may be connected to the connection members 260 and 270 of another battery module. Thus, the connection members 260 and 270 may be electrically connected to the connection members of another battery module.

The battery module 200 may include a driving module (not shown) that controls the electrical connection between the connection members 260 and 270 and the module busbar. For example, the driving module may control the electrical connection between the connection members 260 and 270 and the module busbar by moving at least a part of the connection members 260 and 270 or at least a part of the module busbar.

The battery module 200 may include a controller that, in response to a predetermined condition, controls the driving module to block the electrical connection between the connection members 260 and 270 and the module busbar. The condition may be, for example, a case where the temperature, voltage, current, etc. of the battery module 200 and/or the battery cell reach a predetermined value. Here, the controller may be included in the battery management module and/or the battery controller, and the controller may be implemented through the battery management module and/or the battery controller.

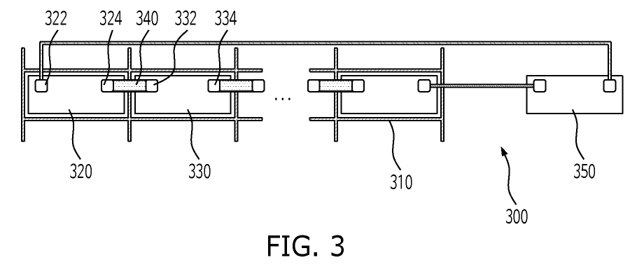

FIG. 3 illustrates a battery rack 300 according to an embodiment of the present disclosure. Here, the battery rack 300 may refer to an energy storage source that accommodates a plurality of battery modules that are connected electrically in series and/or in parallel. The battery rack 300 including a plurality of battery modules may be included in a vehicle, an energy storage system, or the like. The battery rack 300 may include a rack frame 310 that accommodates a plurality of battery modules.

A battery controller 350 may be connected to a first terminal (for example, a positive electrode terminal) and a second terminal (for example, a negative electrode terminal) of the battery modules electrically connected to each other. For example, the battery controller 350 may be connected to a first terminal of a battery module disposed at an end of the battery modules, and the battery controller 350 may be connected to a second terminal of a battery module disposed at the other end of the plurality of battery modules. The battery controller 350 may also be connected to a battery management module included in each of the plurality of battery modules. The battery controller 350 may monitor and integrally manage each of the battery modules.

The battery rack 300 may include a first battery module 320 and a second battery module 330. The first battery module 320 may include a first set of battery cells, and the second battery module 330 may include a second set of battery cells. The first battery module 320 may also include a first connection member 322 electrically connected to a first terminal of the first set of battery cells and a second connection member 324 electrically connected to a second terminal of the first set of battery cells. In addition, the second battery module 330 may include a first connection member 332 electrically connected to a third terminal of the second set of battery cells and a second connection member 334 electrically connected to a fourth terminal of the second set of battery cells.

The battery rack 300 may include a module busbar 340 that electrically connects the second connection member 324 and the third connection member 332. Here, the polarity (i.e., positive, negative) electrically represented by the second connection member 324 may be different from the polarity electrically represented by the third connection member 332. As a result, the first battery module 320 and the second battery module 330 may be connected in series. However, the present disclosure is not limited to such a configuration. In other embodiments, the first battery module 320 and the second battery module 330 may be connected in parallel.

The first battery module 320 may include a first driving module that controls the electrical connection between the second connection member 324 and the module busbar 340. In addition, the second battery module 330 may include a second driving module that controls the electrical connection between the third connection member 332 and the module busbar 340. Additionally or alternatively, the first battery module 320 may include a third driving module for the first connection member 322, and the second battery module 330 may include a fourth driving module for the fourth connection member 334. That is, the battery module may include a driving module for at least one of connection members included in the battery module.

A controller may control a driving module included in each of a plurality of battery modules included in the battery rack 300. Here, the controller may be included in a battery controller 350 included in the battery rack 300 and/or a battery management module included in the battery module. The controller may, in response to a predetermined condition, control the first driving module to block the electrical connection between the second connection member 324 and the module busbar 340. As another example, the controller may, in response to a predetermined condition, control the second driving module to block the electrical connection between the third connection member 332 and the module busbar 340.

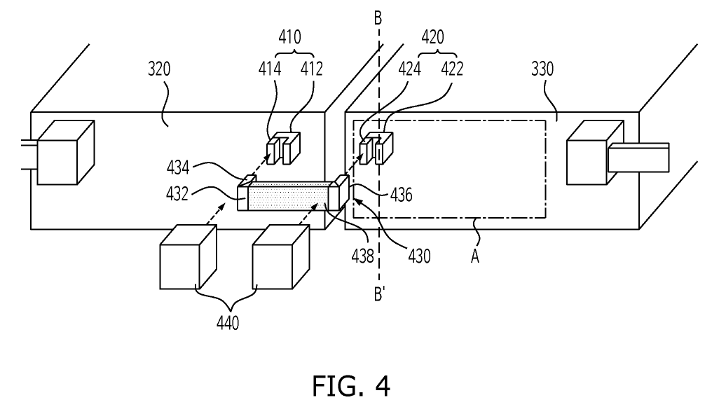

FIG. 4 is a diagram illustrates a first battery module 320 and a second battery module 330 according to an embodiment of the present disclosure. The first battery module 320 may include a first connection member 410 connected to a first terminal of a first set of battery cells, and the second battery module 330 may include a second connection member 420 connected to a second terminal of a second set of battery cells. A module busbar 430 may electrically connect the first connection member 410 and the second connection member 420.

The module busbar 430 may include a first terminal part 434, a second terminal part 436, and a body part 432 to which the first terminal part 434 and the second terminal part 436 are connected. The first terminal part 434 may be connected to the first connection member 410, and the second terminal part 436 may be connected to the second connection member 420. The module busbar 430 may further include an insulating film 438 surrounding the body part 432. The insulating film 437 may prevent a short circuit caused by the module busbar 430 contacting a surrounding object.

The first connection member 410 may include a first conductive part 414 capable of being energized and a first insulating part 412 to which the module busbar 430 is connected. The first insulating part 412 may be fixed on a module frame of the first battery module 320, and the module busbar 430 may be coupled with the first insulating part 412. The module busbar 430 and the first insulating part 412 may be coupled by welding, bolt coupling, or the like. The first insulating part 412 may include an insulating material such that the first insulating part 412 and the module busbar 430 may not be energized with each other.

The first conductive part 414 and the first insulating part 412 may be disposed to face each other. The first terminal part 434 of the module busbar 430 may be disposed between the first conductive part 414 and the first insulating part 412, and the first terminal part 434 may be coupled to the first insulating part 412. Then, a first driving module included in the first battery module 320 may move the first conductive part 414 so that the module busbar 430 and the first conductive part 414 are either in contact with each other or are separated from each other. When the first conductive part 414 and the first terminal part 434 are in contact, the first conductive part 414 and the first terminal part 434 may be electrically connected. But when the first conductive part 414 and the first terminal part 434 are separated, the first conductive part 414 and the first terminal part 434 may be electrically disconnected. That is, as the first conductive part 414 moves, the first connection member 410 and the module busbar 430 may be electrically connected or disconnected.

Similarly, the second connection member 420 may include a second conductive part 414 capable of being energized and a second insulating part 422 to which the module busbar 430 is connected. For example, the second insulating part 422 may be fixed on a module frame of the second battery module 330, and the module busbar 430 may be coupled to the second insulating part 422. The module busbar 430 and the second insulating part 422 may be coupled, for example, by welding, bolt coupling, or the like. The second insulating part 422 may include an insulating material such that the second insulating part 422 and the module busbar 430 may not be energized with each other.

The second conductive part 424 and the second insulating part 422 may be disposed to face each other. The second terminal part 436 of the module busbar 430 may be disposed between the second conductive part 424 and the second insulating part 422, and the second terminal part 436 may be coupled to the second insulating part 422. A second driving module included in the second battery module 330 may move the second conductive part 424 so that the module busbar 430 and the second conductive part 424 are either in contact with each other or are separated from each other. When the second conductive part 424 and the second terminal part 436 are in contact, the second conductive part 424 and the second terminal part 436 may be electrically connected. But when the second conductive part 424 and the second terminal part 436 are separated, the second conductive part 424 and the second terminal part 436 are electrically disconnected. That is, as the second conductive part 424 moves, the second connection member 420 and the module busbar 430 may be electrically connected or disconnected.

In the embodiment depicted in FIG. 4, each of the first connection member 410 and the second connection member 420 includes a conductive part and a terminal part. But the present disclosure is not limited to such a configuration. For example, the first connection member 410 or the second connection member 420 may include a fixed conductive part instead of the conductive part and the terminal part. The fixed conductive part may be electrically connected to one terminal of a set of battery cells (for example, a first set of battery cells, a second set of battery cells). In addition, the fixed conductive part may be electrically connected to the first terminal part 434 or the second terminal part 436 of the module busbar 430. The first terminal part 434 or the second terminal part 436 may be fixedly coupled to the fixed conductive part. That is, the first terminal part 434 of the module busbar 430 may be fixedly coupled with the first connection member 410, or the second terminal part 436 of the module busbar 430 may be fixedly coupled with the second connection member 420.

An insulating case 440 may cover an end of the module busbar 430 connected to the connection member. Further, the insulating case 440 may also cover the connection member connected to the end of the module busbar 430. For example, the insulating case 440 may cover the first terminal part 434 of the module busbar 430 and the first connection member 410. The insulating case 440 may protect the area of the module busbar 430 exposed from the insulating film 438 and the connection member from external objects, thereby preventing short circuits from occurring.

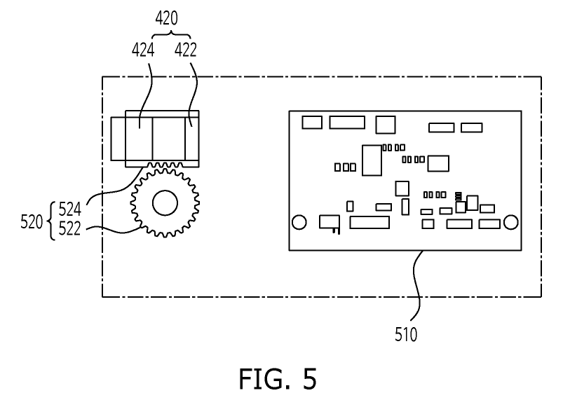

A driving module and a battery management module included in the battery module may be disposed adjacent to the connection member. For example, a second driving module and a battery management module included in the second battery module 330 may be disposed in an area A adjacent to the connection member. Further driving module and/or the battery management module may be disposed inside a frame of the second battery module 330 in the area A around the connection member. The structure of the second connection member 420, the second driving module, and the battery management module will be described in detail below with reference to FIG. 5.

By controlling the electrical connection of the module busbar, the voltage of the battery rack may be controlled. In particular, the electrical connection between a battery module and another battery module among a plurality of battery modules included in the battery rack may be individually controlled. By individually controlling the electrical connection of the battery modules, the battery rack may be more stably controlled in an emergency situation, such as during a fire caused by the battery rack.

FIG. 5 illustrates an area A adjacent to a connection member according to an embodiment of the present disclosure. FIG. 5 shows the inside of a frame of a battery module. In this embodiment, battery module includes a connection member 420, a driving module 520 that controls an electrical connection between the connection member 420 and a module busbar, and a battery management module 510.

The connection member 420 may include a conductive part 424 capable of being energized and an insulating part 422 to which a module busbar is connected. The conductive part 424 and the insulating part 422 may face each other. The conductive part 424 may be connected to a rack and pinion gear 522 and 524. More specifically, the conductive part 424 may be connected to a rack 524, and a pinion 522 may be engaged with the rack 524. As the pinion 522 rotates, the rack 524 moves in a horizontal direction, and the conductive part 424 connected to the rack 524 may move with the rack 524. The conductive part 424 may be coupled in a sliding manner to be movable in a direction toward or away from the insulating part 422.

The driving module 520 may include a motor that rotationally drives the rack and pinion gear 522 and 524. The motor may be disposed behind the pinion 522 as depicted in FIG. 5 and may drive a rotation shaft of the pinion 522. The motor may move the conductive part 424 connected to the rack 524 by rotating the pinion 522 clockwise or counterclockwise.

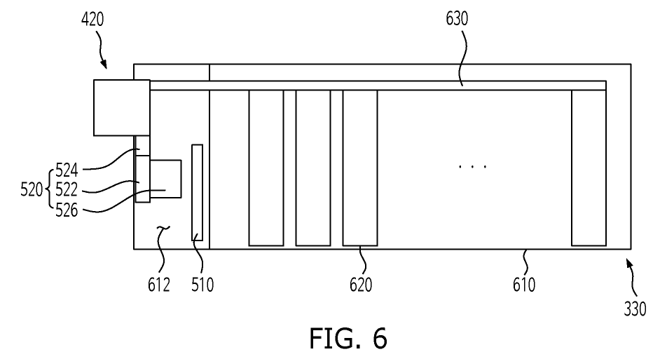

A controller may be included in the battery management module 510 or, additionally or alternatively, may be included in a battery controller. In the embodiment depicted in FIGS. 5 and 6, the controller is included in the battery management module 510. The battery management module 510 may control the motor. For example, the battery management module 510 may transmit a command to operate or stop the motor to the motor.

FIG. 6 is a cross-sectional view of a battery module 330 according to an embodiment of the present disclosure. FIG. 6 is a cross-sectional view of the battery module 330 in a height direction along a line B-B’ crossing the battery module 330 shown in FIG. 4 in a length direction.

A battery module 330 may include a set of battery cells 620 and a module frame 610 that accommodates the set of battery cells 620. The module frame 610 may include a circuit 630 connected to a first terminal and/or a second terminal of the set of battery cells 620. As shown in FIG. 6 the circuit 630 may be connected to a connection member 420. However, the present disclosure is not limited to such a configuration. For example, the connection member 420 may be connected to a busbar connected to the circuit 630. In another example, the connection member 420 may be connected to a busbar connected to a terminal of the set of battery cells 620. That is, the connection member 420 may be electrically connected to the terminal of by being connected to a configuration connected to one terminal of the set of battery cells 620 among the structures included in the battery module 330. However, a case where the circuit 630 and the connection member 420 are connected will be described below.

The circuit 630 may be connected to a conductive part of the connection member 420. When the conductive part contacts a terminal part of a module busbar (as described above), the circuit 630 may be electrically connected to the module busbar. The conductive part may be connected to a rack and pinion gear 522 and 524 of a driving module 520. The rack 524 may move in response to the rotation of the pinion 522, and the conductive part may along with the rack 524. The pinion 522 may be driven by a motor 526 included in the driving module 520. That is, the motor 526 may rotationally drive the rack and pinion gear 522 and 524. And the motor 526 may be controlled by a controller included in the battery management module 510 and/or a battery controller.

The driving module 520 and the battery management module 510 may be disposed in an inner space 612 that is inside of an end plate of the module frame 610. A part of the connection member 420 may also be disposed in the inner space 612. For example, a part of the connection member 420 where the connection member 420 and the circuit 630 are connected may be disposed in the inner space 612. A part of the connection member 420 connected to the rack 524 may be disposed in the inner space 612. In this configuration, the driving module 520 and the battery management module 510, which control the electrical connection, and the electrically connected area of the connection member 420 are protected.

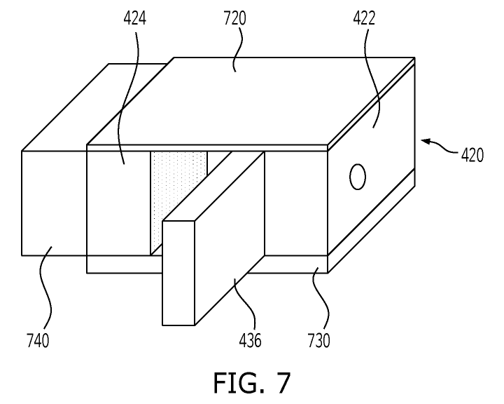

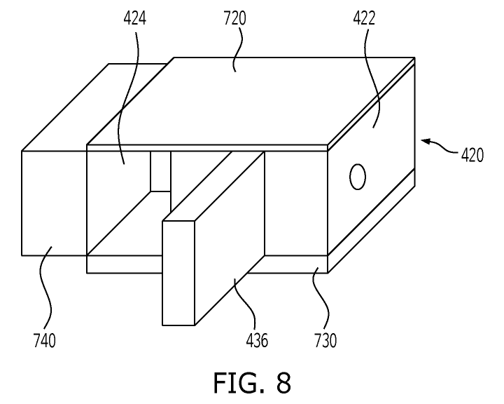

FIG. 7 illustrates a state in which a conductive part 424 and a terminal part 436 are separated. FIG. 8 illustrates a state in which the conductive part 424 and the terminal part 436.

A connection member 420 may include a conductive part 424 capable of being energized and an insulating part 422 to which a terminal part 436 of a module busbar is connected. The insulating part 422 may be fixed on a module frame of a battery module, and the terminal part 436 may be coupled with the insulating part 422. The terminal part 436 and the insulating part 422 may be coupled by welding, bolt coupling, or the like. The insulating part 422 may include an insulating material, so that the insulating part and the terminal part 436 are not electrically connected to each other.

The conductive part 424 and the insulating part 422 may face each other. In particular, the terminal part 436 may be disposed between the conductive part 424 and the insulating part 422, and the terminal part 436 may be coupled with the insulating part 422. The conductive part 424 may be slidable in a direction toward or away from the insulating part 422.

A surface of the conductive part 424 facing the terminal part 436 may be capable of being energized. The surface of the conductive part 424 may be electrically connected to a terminal of a set of battery cells included in a battery module by being connected to a circuit, a busbar, or the like inside the connection member 420. The conductive part 424 may move toward the terminal part 436, and a surface of the conductive part 424 may contact the terminal part 436. Thus, the terminal part 436 of the module busbar may be electrically connected to a terminal of the set of battery cells through the conductive part 424.

An upper cover 720 may cover upper parts of the conductive part 424 and the insulating part 422. A lower cover 730 may cover lower parts of the conductive part 424 and the insulating part 422. A side cover 740 may be disposed next to the conductive part 424. The side cover 740 may prevent the conductive part 424 from being detached in a direction moving away from the terminal part 436. The upper cover 720, the lower cover 730, and the side cover 740 may include an insulating material. The upper cover 720, the lower cover 730, and the side cover 740, may prevent external objects from entering a contact area between the connection member 420 and the terminal part 436.

At least a part of the lower cover 730 may be a rack of a rack and pinion gear. The rack may be connected to the conductive part 424, and the conductive part 424 may move along with the rack.

Referring to FIG. 7, the conductive part 424 may be separated from the terminal part 436. The terminal part 436 and the insulating part 422 are coupled but may be electrically connected to each other. And the conductive part 424 and the terminal part 436 may be electrically disconnected.

Referring to FIG. 8, the conductive part 424 may move toward the terminal part 436. For example, the conductive part 424 may be moved in a sliding manner in a direction toward the terminal part 436 by a rack and pinion gear such that the conductive part 424 moves into contact with the terminal part 436. A surface of the conductive part 424 in contact with the terminal part 436 may be capable of being energized such that the conductive part 424 and the terminal part 436 may be electrically connected.

The conductive part 424 may also move in a direction away from the terminal part 436. For example, the conductive part 424 may be moved in a sliding manner in a direction away from the terminal part 436 by the rack and pinion gear. The connection member 420 thereby moves to the position where the conductive part 424 and the terminal part 436 are electrically disconnected.

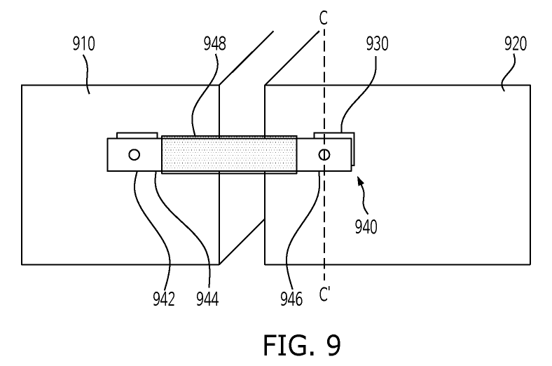

FIG. 9 illustrates a first battery module 910 and a second battery module 920 according to another embodiment of the present disclosure. The first battery module 910 may include a first connection member connected to a first terminal of a first set of battery cells, and the second battery module 920 may include a second connection member connected to a second terminal of a second set of battery cells. A module busbar may electrically connect the first connection member and the second connection member.

The module busbar may include an inner busbar 930 connected to the second connection member and an outer busbar 940 that electrically connects the inner busbar and the first connection member. The outer busbar 940 may include a fixing part 942, a terminal part 946, and a body part 944 to which the fixing part 942 and the terminal part 946 are connected. The fixing part 932 may be electrically connected to the first connection member, and the terminal part 946 may be electrically connected to the inner busbar 930. Thus, module busbar may be electrically connected to the second connection member. The outer busbar 940 may further include an insulating film 948 surrounding the body part 944. Thus, a short circuit caused by the outer busbar 940 contacting a surrounding object may be prevented.

The second battery module 920 may include a driving module that controls an electrical connection between the inner busbar 930 and the outer busbar 940. The driving module may include, for example, a shaft coupled with the inner busbar 930, with the shaft moving together with the inner busbar 930. The driving module may also include a motor that moves the shaft in an axial direction. As the shaft moves to bring the inner busbar 930 into contact with or separate from the outer busbar 940, the electrical connection between the inner busbar 930 and the outer busbar 940 may be controlled. In another example, the driving module may include a shaft electrically connected to the inner busbar 930 and a third motor that rotates and moves the shaft in an axial direction. As the shaft moves to either engage with or disengage from the outer busbar in a screw-type manner, the electrical connection between the inner busbar 930 and the outer busbar 940 may be controlled.

Referring to FIG. 9, the outer busbar 940 may include a fixing part 942 that is coupled to and fixed with the first connection member. Alternatively, the fixing part 942 may be coupled to and fixed with a busbar that is connected to the first connection member. The fixing part 942 and the first connection member may be coupled by a shaft that extends through the fixing part 942 and the first connection member. As other examples, the fixing part 942 may be coupled to the first connection member by bolt coupling, welding, or the like. However, the present disclosure is not limited to these examples, and the outer busbar 940 may include an additional terminal part instead of including the fixing part 942. The module busbar may include an additional inner busbar connected to the first connection member, and the additional terminal part may be electrically connected to the inner busbar and thus be electrically connected to the first connection member. The first battery module 910 may include an additional driving module that controls an electrical connection between the additional inner busbar and the outer busbar 940. That is, the additional driving module may control the electrical connection between the additional inner busbar and the outer busbar 940 in a manner similar to the way the driving module of the second battery module 920 controls the electrical connection between the inner busbar 930 and the outer busbar 940. That is, the fixing part 942 may be disposed at one end of the outer busbar 940 and be fixedly coupled to the first connection member, or an additional terminal part may be disposed at one end of the outer busbar 940, and the electrical connection with the first connection member may be controlled.

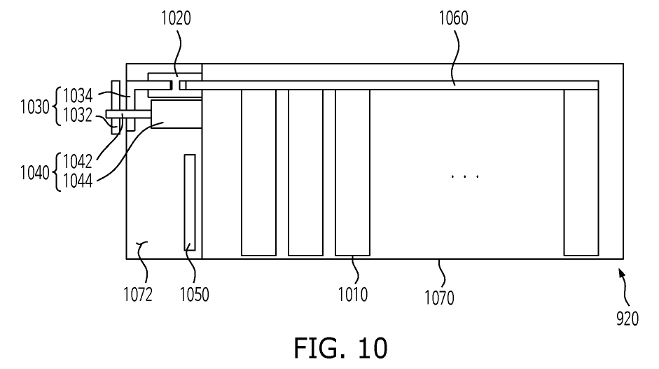

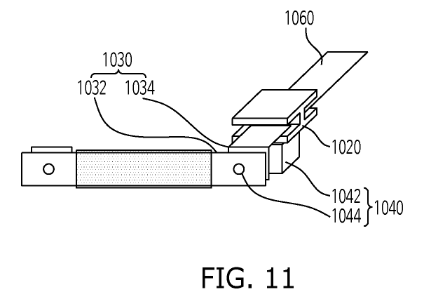

FIG. 10 is a cross-sectional view of a battery module 920 according to another embodiment of the present disclosure. FIG. 11 is a perspective view illustrating a busbar 1030, a connection member 1020, and a driving module 1040 according to this embodiment. FIG. 10 is a cross-sectional view showing the structure of the battery module 920 along a line C-C that crosses the battery module 920 in the length direction as shown in FIG. 9.

A battery module 920 may include a set of battery cells 1010 and a module frame 1070 in which the battery cells 1010 are accommodated. The module frame 1070 may include a circuit 1060 connected to a first terminal and/or a second terminal of the set of battery cells 1010. Referring to FIG. 10, the circuit 1060 may be connected to a connection member 1020. However, the present disclosure is not limited to such a configuration, and the connection member 1020 may be, for example, connected to a busbar connected to the circuit 1060. In another example, the connection member 1020 may be connected to a busbar connected to a terminal of the battery cells 1010. That is, the connection member 1020 may be electrically connected to a terminal of the battery cells 1010 by being connected to a structured connected to a terminal of the battery cells 1010. However, a configuration where the circuit 1060 and connection member 1020 are connected is described below.

The connection member 1020 may include a first insertion part into which an inner busbar 1034 is inserted and a second insertion part into which a part of a circuit 1060 is inserted. The part of the circuit 1060 inserted into the second insertion part may be fixed to the second insertion part by welding or the like. Thus, the connection member 1020 may be electrically connected to the circuit 1060 and electrically connected to the inner busbar 1034.

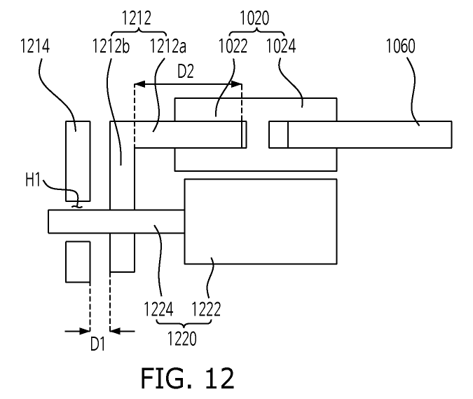

A module busbar 1030 may include an outer busbar 1032 and an inner busbar 1034. The inner busbar 1034 and the outer busbar 1032 may include a through-hole through which a shaft 1042 extends. A driving module 1040 may include the shaft 1042 and a motor 1044. The electrical connection between the inner busbar 1034 and the outer busbar 1032 may be controlled by movement of the shaft 1042. The motor 1044 may be controlled by a controller included in a battery management module 1050 and/or a battery controller. The control of the electrical connection between the inner busbar 1034 and the outer busbar 1032 using the driving module 1040 will be described below with reference to FIGS. 12-14.

At least one of the connection member 1020, the inner busbar 1034, the driving module 1040, and the battery management module 1050 may be disposed in an end plate inner space 1072. Thus, an area where the connection member 1020 and the inner busbar 1034 are electrically connected, an area where the connection member 1020 and the circuit 1060 are electrically connected, the driving module 1040 that controls the electrical connection, and the battery management module 1050 may all be protected.

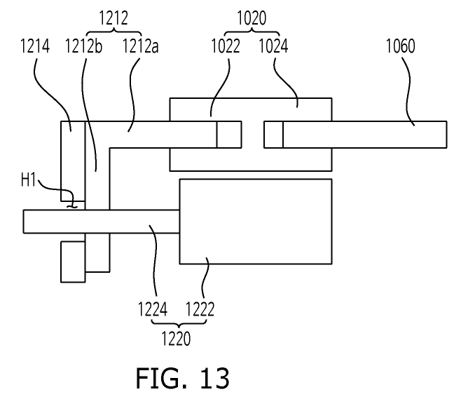

FIG. 12 illustrates a state in which an inner busbar 1212 and an outer busbar 1214 are separated. FIG. 13 illustrates a state in which the inner busbar 1212 and the outer busbar 1214 are in contact.

In an embodiment, an inner busbar 1212 may include a bent part 1212a connected to the first insertion part 1022 and a contact part 1212b for contacting an outer busbar 1214. The first insertion part 1022 may be inserted into the connection member 1020. A circuit 1060 may be inserted into a second insertion part 1024 of the connection member 1020. The part of the circuit 1060 inserted into the second insertion part 1024 may be fixedly coupled to the second insertion part 1024. The bent part 1212a may extend a length into the space of the first insertion part 1022.

A driving module 1220 may include a shaft 1224 and a motor 1222 that moves the shaft 1224 in an axial direction. The driving module 1220 may be, for example, a linear actuator. The shaft 1224 may be coupled by extending through the contact part 1212b of the inner busbar 1212. Thus, as the shaft 1224 moves in the axial direction, the contact part 1212b may move with the shaft 1224.

The outer busbar 1214 may include a through-hole H1 through which the shaft 1224 extends. A diameter of the through-hole H1 may be larger than a width of the shaft 1224. As a result, the shaft 1224 may extend through the through-hole H1 but not contact the outer busbar 1214.

Referring to FIG. 12, the contact part 1212b and the outer busbar 1214 may be spaced apart. Accordingly, the inner busbar 1212 including the contact part 1212b may be electrically disconnected from the outer busbar 1214.

Referring to FIG. 13, as a motor 1222 moves a shaft 1224 in an axial direction, a contact part 1212b coupled to the shaft 1224 may move in a direction towards the outer busbar 1214. The contact part 1212b of the inner busbar 1212 may contact the outer busbar 1214. Thus, the inner busbar 1212 and the outer busbar 1214 may be electrically connected.

Then, as the motor 1222 moves the shaft 1224 in an opposite direction, the contact part 1212b coupled to the shaft 1224 may move away from the outer busbar 1214. The contact part 1212b of the inner busbar 1212 may be separated from the outer busbar 1214. Thus, as in FIG. 12, the inner busbar 1212 and the outer busbar 1214 may be electrically disconnected.

A length D2 of a bent part of an inner busbar 1212 inserted into a first insertion part 1022 may be longer than a distance D1 that the inner busbar moves based on a length direction of a shaft 1224. As such, a length of the first insertion part 1022 may be equal to or longer than the length D2 of the bent part. Thus, the bent part 1212a may extend in the space of the first insertion part 1022 without being detached from the first insertion part 1022.

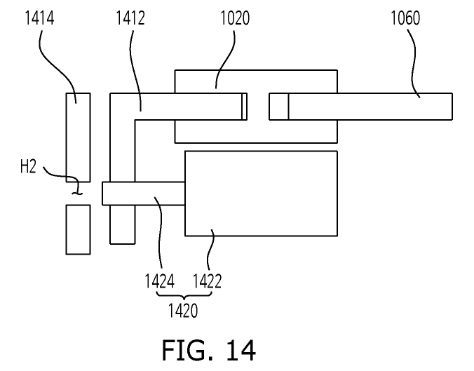

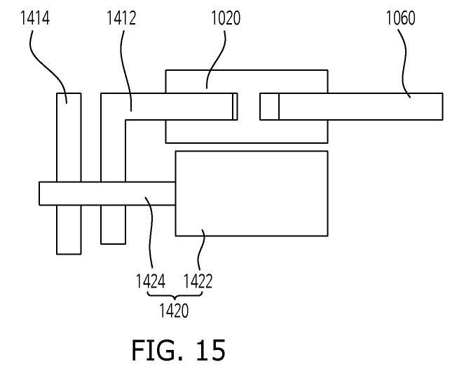

FIG. 14 illustrates a state in which a shaft 1424 and an outer busbar 1414 are separated according to a second embodiment of the present disclosure. FIG. 15 illustrates a state in which an inner busbar 1424 and the outer busbar 1414 are in contact according to the second embodiment of the present disclosure.

An inner busbar 1412 may include a bent part inserted into a first insertion part and a contact part for contacting an outer busbar. A connection member 1020 may include the first insertion part into which the bent part of an inner busbar 1212 is inserted and a second insertion part into which a part of a circuit 1060 is inserted. The part of the circuit 1060 inserted into the second insertion part may be fixed to the second insertion part. And the inner busbar 1412 inserted into the first insertion part may be fixed to the first insertion part.

A driving module 1422 may include a shaft 1424 and a motor 1422 that moves the shaft 1424 in an axial direction. The driving module 1422 may be, for example, a linear actuator. The shaft 1224 may extend through a contact part 1212b of an inner busbar 1212.

The shaft 1424 may include a male screw shape on at least a part of a circumference of the shaft 1424. The inner busbar 1412 may include a first female screw hole corresponding to the male screw part, and an outer busbar 1414 may include a second female screw hole H2 corresponding to the male screw part. When the shaft 1424 moves in an axial direction, the shaft 1424 may move through the first female screw hole and the second female screw hole H2.

The motor 1422 may rotate and/or move the shaft 1424 in an axial direction. As inner busbar 1412 is fixed connection member 1020, and the shaft 1424 may move axially through an inside of a first female screw hole in a screwing manner.

Referring to FIG. 14, a shaft 1424 may be separated from an outer busbar 1414 and may be in contact with an inner busbar 1412. That is, the shaft 1424 may be inserted into the first female screw hole of the inner busbar 1412 without being inserted into a second female screw hole H2 of the outer busbar 1414. In this configuration, the shaft 1424 and the inner busbar 1412 may be electrically connected to each other and may be electrically disconnected from the outer busbar 1414.

Referring to FIG. 15, as a motor 1422 rotates and/or moves a shaft 1424 in an axial direction, the shaft 1424 may move in a direction closer to a second female screw hole of an outer busbar 1414. Then the shaft 1424 may engage the second female screw hole, thereby contacting the outer busbar 1414 in a screwing manner. Accordingly, the outer busbar 1414 and the shaft 1424 are electrically connected, and the shaft 1424 may be electrically connected to an inner busbar 1412.

Then, as the motor 1422 rotates and/or moves the shaft 1424 in the opposite direction, the shaft 1424 may move in a direction away from the outer busbar 1414. The shaft 1424 may become detached from the second female screw hole. Thus, as in FIG. 14, the inner busbar 1412 and the outer busbar 1414 may be electrically disconnected.

The shaft 1424 may include an insulating layer disposed between the male screw part and the motor 1422. The insulating layer may prevent a short circuit between the motor 1422 and the shaft 1424 as the shaft 1424 is electrically connected to the inner busbar 1412.

Although the present disclosure has been described above with respect to embodiments thereof, the present disclosure is not limited thereto. Various modifications and variations can be made thereto by those skilled in the art.

### DESCRIPTION OF REFERENCE NUMERALS

100: battery cell
110: case
120: cap plate
130_1: positive electrode terminal
130_2: negative electrode terminal
140: vent part
150: electrolyte injection port

What is claimed is:

1. A battery rack comprising:
a first battery module comprising:
a first set of battery cells, and
a first connection member electrically connected to a first terminal of the first set of battery cells;
a second battery module comprising:
a second set of battery cells, and
a second connection member electrically connected to a second terminal of the second set of battery cells;
a module busbar electrically connecting the first connection member and the second connection member; and
a driving module configured to control an electrical connection between the first connection member and the module busbar, the driving module including a motor.

2. The battery rack as claimed in claim 1, further comprising a controller configured to control the first driving module to block the electrical connection between the first connection member and the module busbar in response to a predetermined condition.

3. The battery rack as claimed in claim 1, wherein the first connection member comprises a conductive part capable of being energized, and an insulating part to which the module busbar is connected, and
wherein the first driving module is configured to move the conductive part such that the module busbar and the conductive part are in contact or are separated.

4. The battery rack as claimed in claim 3, wherein the conductive part and the insulating part face each other, and the conductive part and the insulating part are coupled in a sliding manner so to be movable in a direction toward or away from each other.

5. The battery rack as claimed in claim 3, wherein the first driving module comprises a rack and pinion gear connected to the conductive part, and
wherein the motor is configured to rotationally drive the rack and pinion gear.

6. The battery rack as claimed in claim 3, wherein the module busbar comprises:
a first terminal part coupled to the insulating part;
a second terminal part connected to the second connection member; and
a body part connecting the first terminal part and the second terminal part.

7. The battery rack as claimed in claim 6, wherein the module busbar further comprises an insulating film surrounding the body part.

8. The battery rack as claimed in claim 6, wherein the driving module is a first driving module, the motor is a first motor, the conductive part is a first conductive part, and the insulating part is a first insulating part,
wherein the battery rack further comprises a second driving module configured to control an electrical connection between the second connection member and the module busbar, with the second driving module including a second motor,
wherein the second connection member comprises a second conductive part capable of being energized and a second insulating part to which the module busbar is connected, and
wherein the second driving module is configured to move the second conductive part such that the module busbar and the second conductive part are in contact or are separated.

9. The battery rack as claimed in claim 6, wherein the second connection member is fixedly coupled to the second terminal part.

10. The battery rack as claimed in claim 1, wherein the module busbar comprises an inner busbar connected to the first connection member, and an outer busbar for electrically connecting the inner busbar and the second connection member, and
wherein the driving module is configured to control an electrical connection between the inner busbar and the outer busbar.

11. The battery rack as claimed in claim 10, wherein the driving module comprises a shaft coupled to the inner busbar to move together with the inner busbar, with the motor being configured to move the shaft in an axial direction, and
wherein, as the shaft moves the inner busbar into contact with or separate from the inner busbar from the outer busbar, the electrical connection between the inner busbar and the outer busbar is controlled.

12. The battery rack as claimed in claim 11, wherein the outer busbar comprises a through-hole through which the shaft extends, and a diameter of the through-hole is greater than a width of the shaft.

13. The battery rack as claimed in claim 11, wherein the first connection member comprises an insertion part into which the inner busbar is inserted, and the inner busbar comprises a bent part inserted into the insertion part.

14. The battery rack as claimed in claim 13, wherein a length of the bent part is longer than a distance that the inner busbar can move in a length direction of the shaft.

15. The battery rack as claimed in claim 11, wherein the shaft is a first shaft and the motor is a first motor,
wherein the driving module comprises a second shaft electrically connected to the inner busbar, and a second motor configured to rotate and move the second shaft in an axial direction, and
wherein, as the second shaft moves to contact or separate from the outer busbar, the electrical connection between the first inner busbar and the outer busbar is controlled.

16. The battery rack as claimed in claim 15, wherein the second shaft comprises a male screw part, the outer busbar comprises a female screw hole corresponding to the male screw part, and the male screw part of the second shaft is configured to be screwed into or unscrewed from the female screw hole.

17. The battery rack as claimed in claim 10, wherein the outer busbar further comprises a fixing part coupled and fixed to the second connection member.

18. The battery rack as claimed in claim 10, wherein the motor is a first motor and the inner busbar is a first inner bus bar,
wherein the module busbar further comprises a second inner busbar connected to the second connection member and electrically connected to the first inner busbar by the outer busbar, and
wherein the battery rack further comprises a second driving module configured to control the electrical connection between the second inner busbar and the outer busbar, with the second driving module including a second driving motor.

19. The battery rack as claimed in claim 1, further comprising an insulating case covering an end of the module busbar connected to the first connection member.

20. A battery rack comprising:
a first battery module comprising:
a first set of battery cells, and
a first connection member electrically connected to a first terminal of the first set of battery cells;
a second battery module comprising:
a second set of battery cells, and
a second connection member electrically connected to a second terminal of the second set of battery cells;
a module busbar electrically connecting the first connection member and the second connection member;
a driving module configured to move at least a part of the first connection member or at least a part of the module busbar to control an electrical connection between the first connection member and the module busbar, the driving module including a motor; and
a controller configured to control the driving module to block the electrical connection between the first connection member and the module busbar in response to a predetermined condition.
